(19) United States
(12) Patent Application Publication
(10) Pub. No.: US 2002/0161916 A1
(43) Pub. Date: Oct. 31, 2002

(54) Multichannel network, network connection, and switching apparatus

(76) Inventor: Yoshiteru Chiba, Yokohama (JP)

Correspondence Address: YOUNG & THOMPSON, 745 SOUTH 23RD STREET 2ND FLOOR, ARLINGTON, VA, 22202

(21) Appl. No.: 09/843,745

(22) Filed: Apr. 30, 2001

(51) Int. Cl. G06F 15/16; G06F 15/173

(52) U.S. Cl. 709/238; 709/250

(57) ABSTRACT

A multichannel network through which data of telephone line, animation data, etc. are transmitted and received can continuously transfer data by connecting data between a source and a destination through a substantially exclusive connection although there arises a relaying, branching, or replicating process depending on the data type such as documents, voice, animation, etc. Furthermore, by assigning physically respective channels to different data types, interference by other channels can be successfully avoided. That is, a server is connected to a plurality of clients which can be personal computers PC 1 through PC 4 through cables b through e. The personal computers PC 1 through PC 4 are connected to push-button telephones T1 through T4 through cables j through m. In the cables b through e, different twisted pair lines are used for each channel so that communications data for a personal computer and voice data for a telephone are transmitted through different channels, thereby successfully avoiding discontinuous voice data and defective communications data. Furthermore, cables can be easily managed, and a less costly system can be realized.

### BACKGROUND OF THE INVENTION

1. Field of the Invention

The present invention relates to a multichannel network for transmitting and receiving various types of data such as data through telephone lines, animation data, etc.

2. Description of the Prior Art

Recently, computer networks such as Internet, Intranet, etc. have been widely established, and a large volume of information has been transmitted and received through the networks. For example, the information can be communications information, voice information, animation information, etc. When the information is transmitted and received through the networks, it is, for example, put in a packet, and transmitted from a transmitter to a receiver.

FIG. 1 shows the configuration of the system of a communications network. The system shown in FIG. 1 is an example of an in-house LAN (local area network).

A server 51 is a computer for controlling the system of the LAN, and is connected to four personal computers (hereinafter referred to as PC) 53 through 56. Push-button telephones 57 through 60 are provided near the PC 53 through 56, and each of the push-button telephones 57 through 60 is directly connected to a private branch exchange (PBX) 61.

With the above mentioned configuration,

(a) Each client operates the keyboard and the mouse of the PC 53 through 56, transmits/receives document information and image information to and from another client, and communicates with an external computer by connection to Internet, a WAN (wide area network), etc. through the server 51.

On the other hand, when a telephone is used, the user operates push-button telephones 57 through 60 to establish communications. In this case, the voice information is transmitted to the PBX 61 through a dedicated telephone line, and connected to a public telephone line.

(b) On the other hand, in the above mentioned system, a signal transmitted through a network cable refers to document data, voice data, animation data, etc. put in packets. The data is transmitted through the same cable (physical transmission medium). Therefore, problems can occur by the transmission status of other packets, the traffic status of a network, and other factors. For example, when voice data is transmitted, the voice is discontinuously output. In addition, when animation data is transmitted, discontinuous images can be detected.

Therefore, a protocol has been suggested such that transmission of a packet of a specific data type through a network can be reserved as much as possible. Furthermore, a method of dividing data for a plurality of frequencies through the same cable (on the same physical transmission medium), and transmitting the divided data in parallel at a higher transmission speed has also been suggested.

However, the following problems have to be solved in the above mentioned network environment.

First, in the case (a) above, the computer line and the telephone line are separately installed. For example, when a PC is provided near a push-button telephone, it is necessary to separately install respective cables. As a result, cable management becomes complicated, and system installation is costly.

On the other hand, in the case (b) above, although the transmission of packets can be reserved as much as possible through a network, each piece of packet data is transmitted and received through the same cable (same physical transmission medium) as in the conventional technology. Therefore, when there arises congestion during the communications due to heavy traffic, discontinuous voice information and animation information occur as described above.

In addition, when data is divided for a plurality of frequencies, and transmitted in parallel through the same cable, the process is performed in the same cable, and the above mentioned problem occurs when the congestion arises during the communications.

Furthermore, there has been the technology of performing an apparent broadcast with a plurality of users through one channel, but the entire band of the channel cannot be used for the destinations.

### SUMMARY OF THE INVENTION

According to the present invention, data can be continuously transmitted by connecting a transmitter to a receiver through a logically exclusive connection system although a relaying, branching or replicating process is performed depending on the data type such as a document, voice, animation, etc. Additionally, by assigning a physically individual channel to each data type, communications can be realized with the interference of other channels successfully reduced.

In addition, the present invention provides the function of establishing communications with each destination for each channel by making the best of the band of the assigned channel.

According to the present invention, the above mentioned purpose can be attained by providing a multichannel network obtained by installing different types of data through different channels in a plurality of physical transmission media.

That is, according to the present invention, in the communications network using twisted pair lines as physical transmission media, a plurality of twisted pair lines are used to perform the grouping process, thereby using a plurality of channels. The channel in the present invention refers to the unit effective for communications for each group. For example, if there is the dependence between two lines such as a voice data line and a control line, a communications line and a control line, etc., and no communications are established without the dependence, each group of dependence refers to a channel.

Furthermore, when communications lines included in a dependence group are effective only if they are connected to the same destination, the dependence group refers to a channel. In addition, each channel capable of performing a function itself can be independently referred to as a channel. The communications line itself can also be used by adding the control data of other channels or its own channel to the packet data transmission channel as packet data.

Additionally, according to the present invention, in a multichannel network including a plurality of terminal devices configured by a computer and appliances connected to the computer, the computer and the server are connected to a cable having lines of different channels for each type of data. The computer and the appliances connected to the computer can be realized by providing a multichannel network for transmitting and receiving data to and from a destination.

Other appliances connected to the computer can be a telephone and a television camera. These appliances are connected to the computer, and connected to the cable for connecting the server to the computer as another channel.

With the configuration, the wiring for the terminal devices such as a telephone, a television camera, etc. can be included in the network wiring, thereby realizing easier cable management, and reducing the wiring cost for the cable.

Furthermore, the present invention provides a LAN card including the function of inputting telephone voice, a LAN card including the function of inputting a camera, and a LAN card including the function of adding a voice line to a sound card.

That is, each type of signal can be connected and disconnected by connecting a LAN card to PC 1 through PC 4 without using a combination connector.

### BRIEF DESCRIPTION OF THE DRAWINGS

FIG. 1 shows the configuration of the system of a network;

FIG. 2 shows an example of the apparatus according to the first embodiment of the present invention, and an example of a physical transmission medium configured by eight twisted pair lines;

FIG. 3 shows a device for connecting a computer to a network, and shows the configuration of a branch device for externally branching a part of channel;

FIG. 4 shows an example of a network connection and switch device used in a network according to an embodiment of the present invention, and shows an example of an appliance capable of connecting four cables;

FIG. 5 shows the configuration of the system of the multichannel network according to the second embodiment of the present invention;

FIG. 6 shows an example of connecting a PC to a push-button telephone;

FIG. 7(a) is an oblique view of a combination connector;

FIG. 7(b) shows internal connection lines;

FIG. 8(a) is an oblique view of the front view of the branch adapter;

FIG. 8(b) is an oblique view of the reverse side of the branch adapter;

FIG. 8(C) shows an example of connecting a cable;

FIG. 9 shows internal connection lines of the branch adapter;

FIG. 10 is a flowchart of the processing operation according to the third embodiment of the present invention;

FIG. 11 shows the configuration of the system according to the fourth embodiment of the present invention;

FIG. 12 is a flowchart of the processing operation according to the fourth embodiment of the present invention;

FIG. 13(a) shows an example of the configuration of the LAN card including an RJ-45 connector and an RJ-11 connector;

FIG. 13(b) shows an example of the LAN card including a combination connector;

FIG. 13(c) shows an example of a LAN card to which a sound card can be connected; and

FIG. 13(d) shows an example of a LAN card having a camera input terminal.

### DESCRIPTION OF THE PREFERRED EMBODIMENT

The embodiments of the present invention are described below by referring to the attached drawings.

<First Embodiment>

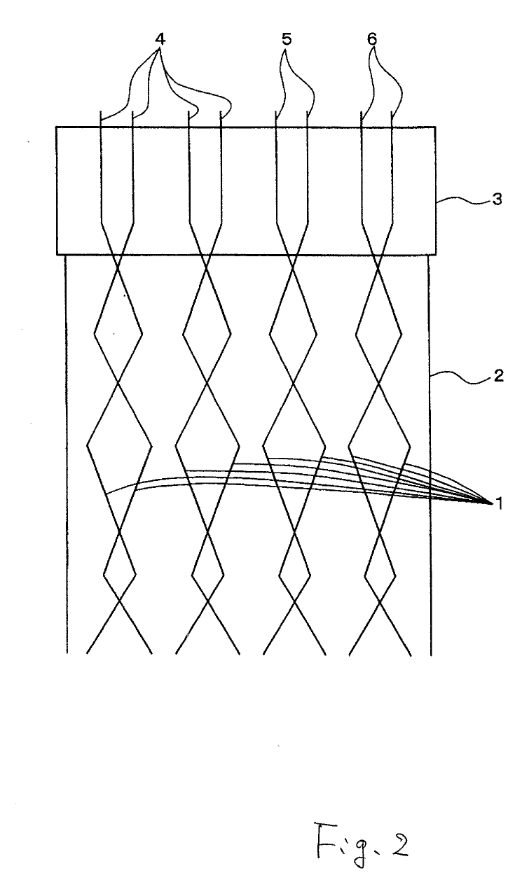

FIG. 2 shows an example of the apparatus according to the present embodiment, and a physical transmission medium is configured by eight twisted pair lines. In the eight lines, four lines are used for a data transmission channel, two lines are used for voice data, and the remaining two lines are used for animation data. That is, the lines are used for three channels.

In FIG. 2, 1 denotes twisted pair lines, 2 denotes cable coating, 3 denotes a connector, 4 denotes four twisted pair lines assigned for data transmission, 5 denotes two twisted pair lines assigned for transmitting voice data, and 6 denotes two twisted pair lines assigned for transmitting animation data. The channels can be arbitrarily assigned if they are consistently assigned among the appliances connected to the communications network, and no problems occur in the communications.

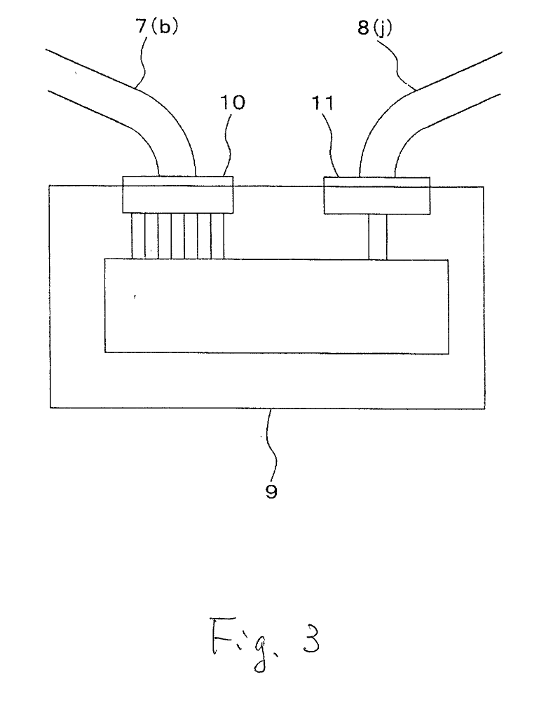

FIG. 3 shows a device for connecting a computer to a network, and has the function of externally branching a part of channels. Four twisted pair lines are used as a channel for data communications from the network side, and other two twisted pair lines are used as two channels for mutually transmitting voice data. Data for use in data communications is fetched to the computer side, and data for voice communications flows from 11 and 8 to an external appliance. For example, a telephone and a head set are connected to 8.

The processes of connecting, transferring, and switching voice data to be transmitted to 11 and 8 can be performed by a computer, etc. to or in which a device 9 is connected or stored. For example, the destination of voice data can be changed by inputting information using the keyboard of the computer, etc., controlling the change by the computer itself, transmitting the control information through the data communications channels 10 and 7, and notifying the destination appliance or an appliance for controlling the connection, whereby allowing the appliance to control the change.

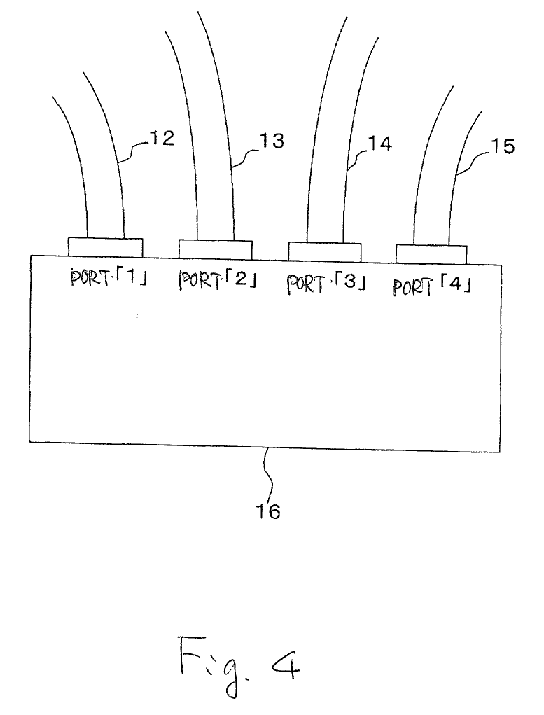

FIG. 4 shows an example of connecting a network and a switch device used in the present embodiment. It shows an example of an appliance which can connect four cables. In the following explanation, a connector which can connect a cable is referred to as a port. As described above by referring to FIG. 2, the example includes a network, a connector, and a cable.

In the example shown in FIG. 2 above, three channels are installed in a table, a connector, and a connection port Therefore, three channels are also installed to each port according to the present embodiment. Since the cable is used as shown in FIG. 2, the configuration is not described here. In the description by referring to FIG. 4, 12 shown in the figure denotes a port 1, 13 denotes a port 2, 14 denotes a port 3, and 15 denotes a port 4.

First, the channel 1 of the port 1 is used in transmitting data, and transmits and receives data to and from another port as necessary. The channel 2 of the port 1 is used in mutually communicating voice, and connected to, for example, the port 3. The channel 2 of the port 1 is used in transmitting pictures, and connected to, for example, the port 4. The connecting processes are performed by the appliance 16. Therefore, the connection status is not shown in FIG. 4.

With the configuration above, the channel 1 of the port 1 (12 shown in FIG. 4) apparently performs a broadcast in a time-sharing system with a plurality of destinations such as the port 2 (13 shown in FIG. 4), the port 3 (14 shown in FIG. 4), the port 4 (15 shown in FIG. 4), etc. by transmitting a packet. Furthermore, the mutual voice data through the channel 2 of the port 1 can be communicated through an available band without interference by the traffic of the channels 1 and 2.

As described above, according to the multichannel network of the present embodiment, the load of the network and the traffic congestion can be reduced, and the problem of the discontinuity of voice data, etc. can be solved.

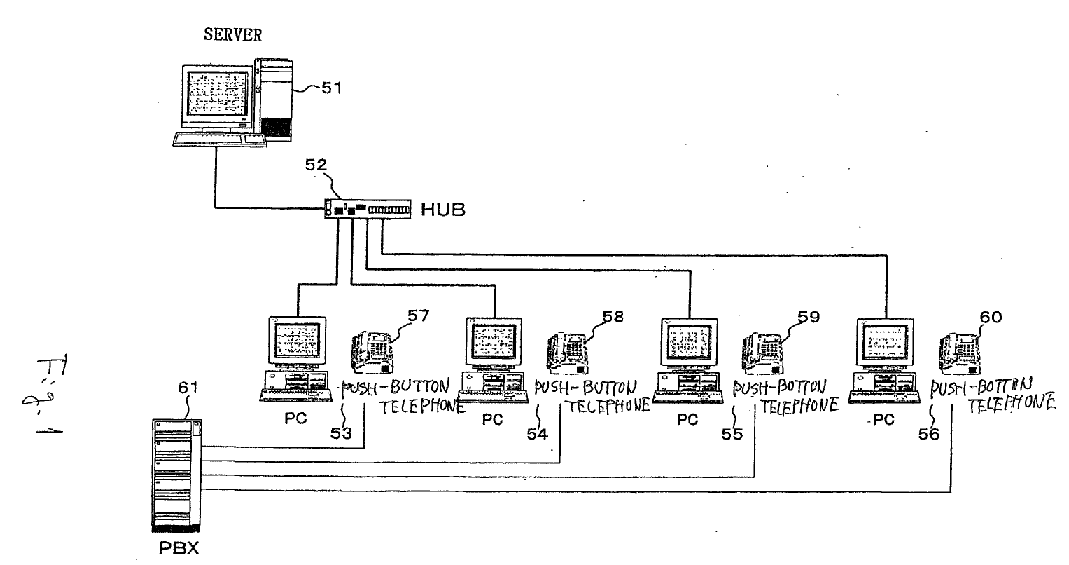

In FIG. 1 above, a push-button telephone is required as a unit for the private branch exchange (PBX). However, in the multichannel network according to the present embodiment, the push-button telephone is not always required as a unit of the private branch exchange (PBX), but can be replaced with a less costly home telephone.

<Second Embodiment>

Described next is the second embodiment.

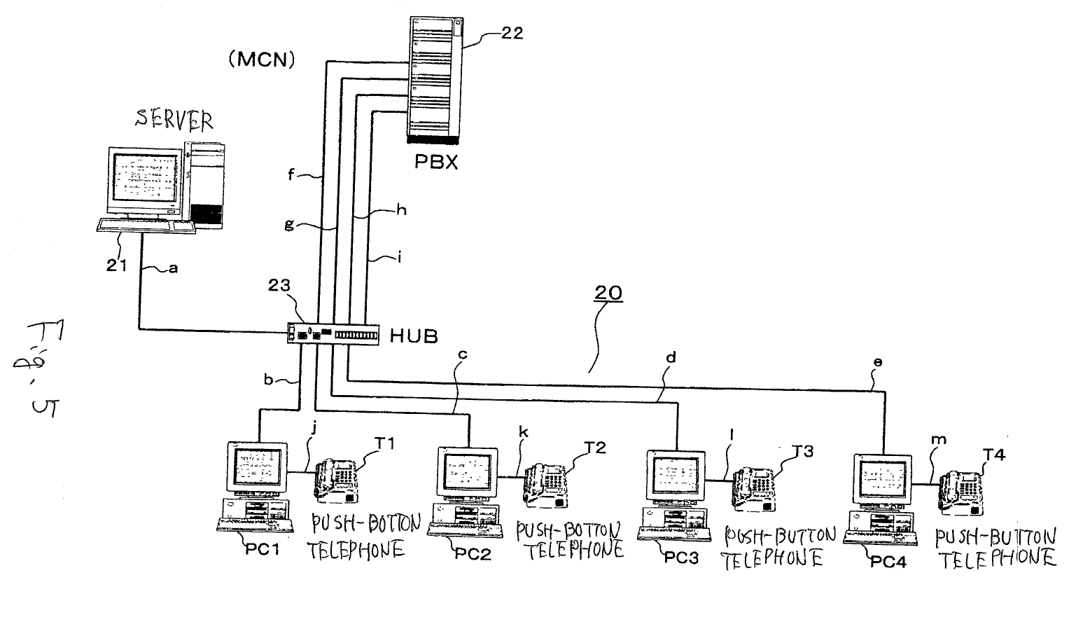

FIG. 5 shows the configuration of the system of the multichannel network according to the present embodiment. In FIG. 5, a network 20 is, for example, an in-house LAN, and comprises a server 21, a private branch exchange (PBX) 22, a HUB 23, four personal computers PC 1 through PC 4, which are clients, and telephones T1 through T4 connected respectively to the personal computers PC 1 through PC 4.

The server 21 provides information from the database not shown in the attached drawings for the client connected to the network 20, and manages a printer device connected to the network 20 but not shown in the attached drawings. Furthermore, the server 21 stores a router, and is connected to an external WAN and Internet to transmit and receive data. The server 21 is connected to the HUB 23 through a cable a.

The HUB 23 connects a server to a client to establish the network 20, and connects and switches the server 21 and the personal computers PC 1 through PC 4. Practically, a device 16 shown in FIG. 4 functions as the HUB 23. The device 16 shown in FIG. 4 has four ports 1 through 4 as described above, and each of the ports 1 through 4 is connected to a client (personal computer) through a cable. Assuming that the device 16 shown in FIG. 4 is the HUB 23 shown in FIG. 5, the network 20 is configured as follows. That is, the port 1 of the HUB 23 (device 16) is connected to the personal computer PC 1 through a cable b. The port 2 is connected to the personal computer PC 2 through a cable c. The port 3 is connected to the personal computer PC 3 through a cable d. The port 4 is connected to the personal computer PC 4 through a cable e.

Furthermore, the HUB 23 is connected to the private branch exchange (PBX) 22 through a telephone line. The private branch exchange (PBX) 22 connects an in-house push-button telephone to a public telephone line, and can be, for example, a digital exchange. The private branch exchange (PBX) 22 and the HUB 23 are connected to each other through, for example, four telephone lines. The connection of the above mentioned telephone line to the device 16 (HUB 23) shown in FIG. 4 is omitted. The above mentioned four telephone lines are indicated by cables f through i.

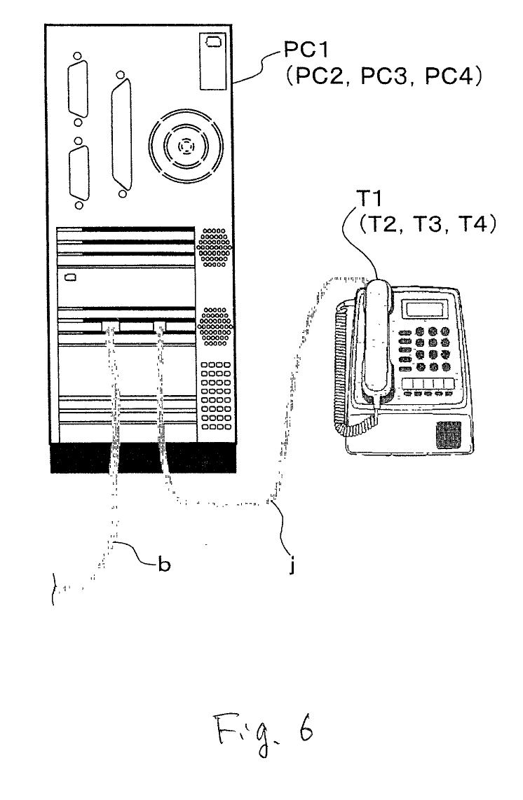

On the other hand, the personal computers PC 1 through PC 4 are connected to corresponding telephones T1 through T4. That is, the telephone T1 is connected to the personal computer PC 1. The telephone T2 is connected to the personal computer PC 2. The telephone T3 is connected to the personal computer PC 3. The telephone T4 is connected to the personal computer PC 4. FIG. 6 is an oblique view of the connection of a personal computer PC to a push-button telephone, and shows the connection between, for example, the personal computer PC 1 and the telephone T1.

The cable b is connected to the personal computer PC 1 as described above, and the personal computer PC 1 is connected to the telephone T1 through a cable j. The cable b is made of eight twisted pair lines, and has been described by referring to FIG. 2. However, the cables b through e used in the present embodiment are four twisted pair lines used in the communications through a network, and two twisted pair lines 5 and 6 are used in voice communications. Therefore, four twisted pair lines are used in voice communications two of which are used for controlling the PBX.

The cable j is made of four twisted pair lines. The configuration of the cable is not practically shown in the attached drawings, but, as described above, two twisted pair lines are used in voice communications, and the remaining two twisted pair lines are used in controlling the PBX.

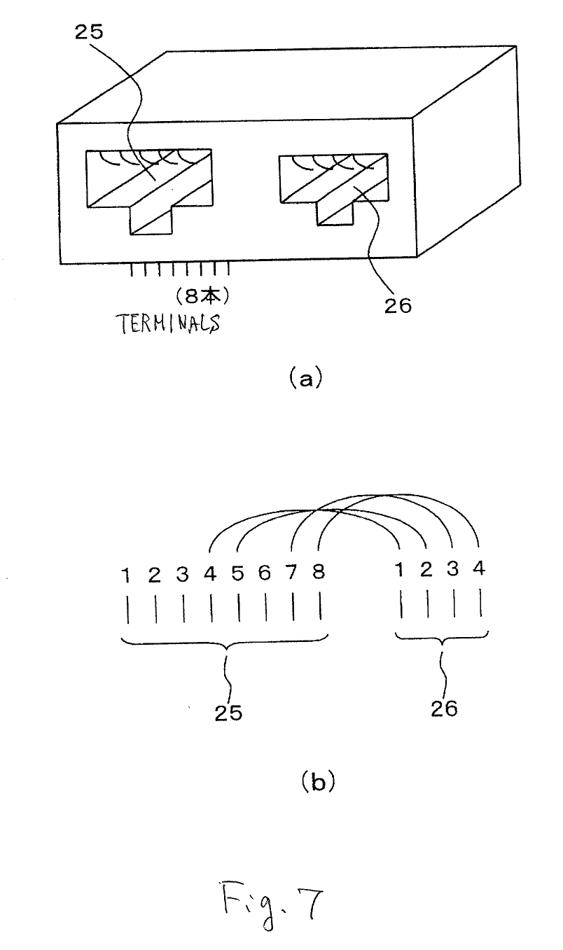

In the personal computer PC 1, a combination connector for connecting the twisted pair lines between the cables b and j is provided. FIG. 7A shows an example of a combination connector, and has the internal wiring shown in FIG. 7B. That is, the cable b having eight twisted pair lines are connected to a connector 25, and the cable j having four twisted pair lines is connected to a connector 26. The communications data provided through the twisted pair lines of the cable b is fetched as is to the personal computer PC 1, and the voice data is transmitted to the above mentioned telephone T1 through the cable j.

In the explanation above, the connection between the personal computer PC 1 and the telephone T1 is described, but it is similar to the connection between other personal computers PC 2 through PC 4 and respectively corresponding to the telephones T2 through T4. That is, the combination connector shown in FIG. 7A is connected to each of the personal computers PC 2 through PC 4. Each of them is connected to the telephones T2 through T4 respectively through cables k through m.

A combination connector having no internal wiring can be used as the above mentioned combination connector. In this case, for example, the voice data fetched through the cable b is processed by a board not shown in the attached drawings, or the voice data fetched through the cable j is processed by the above mentioned board, and transmitted to the other line.

Described below are the operations of the processes according to the present embodiment.

First, when a process is performed by the personal computers PC 1 through PC 4 through the network 20 without the telephones T1 through T4, data and programs are obtained from the server 21, and the personal computers PC 1 through PC 4 transmit and receive mail to and from one another. They also access other networks and Internet through the server 21 to transmit and receive necessary information. In this case, the data output from the personal computers PC 1 through PC 4 is, for example, document data and image data, and communications data is transmitted through cables and the HUB 23.

For example, the personal computer PC 1 is described. The communications data is output from the combination connector in the personal computer PC 1 to the cable b, and then to the server 21 through the HUB 23. Inversely, data is transmitted from the server 21 to the HUB 23, the combination connector through the cable b, and then to the personal computer PC 1. During the process, the data is transmitted through the cable b and the combination connector using the above mentioned twisted pair lines 4.

On the other hand, when the push-button telephones T1 through T4 are used, the voice data is transmitted through the twisted pair lines 5 and 6 in the cables b through e. For example, when the push-button telephone T1 is used, dial information and voice data are input to the combination connector through the cable j, and then to the cable b. At this time, voice data is transmitted and received using the twisted pair lines 5 and 6 in the cable b. The voice data is transmitted to the private branch exchange (PBX) 22 through the HUB 23, the telephone line f, and from the private branch exchange (PBX) 22 to a public line. Therefore, although the cable b of the network 20 is used, the twisted pair lines 5 and 6 are dedicated lines for mutual voice communications without interference by other channels. Similar processes are performed when other push-button telephones T2 through T4 are used. That is, since the twisted pair lines 5 and 6, which are dedicated lines for mutual voice communications, there is no interference by other channels.

As described above, according to the present embodiment, voice data can be transmitted and received through the conventional communications network is used to transmit and receive voice data. Therefore, the cables for telephones can be omitted, thereby simplifying the management of cables, and more effectively utilizing the space. Furthermore, since it is not necessary to additionally mount dedicated cable as a telephone line, the entire system is less costly.

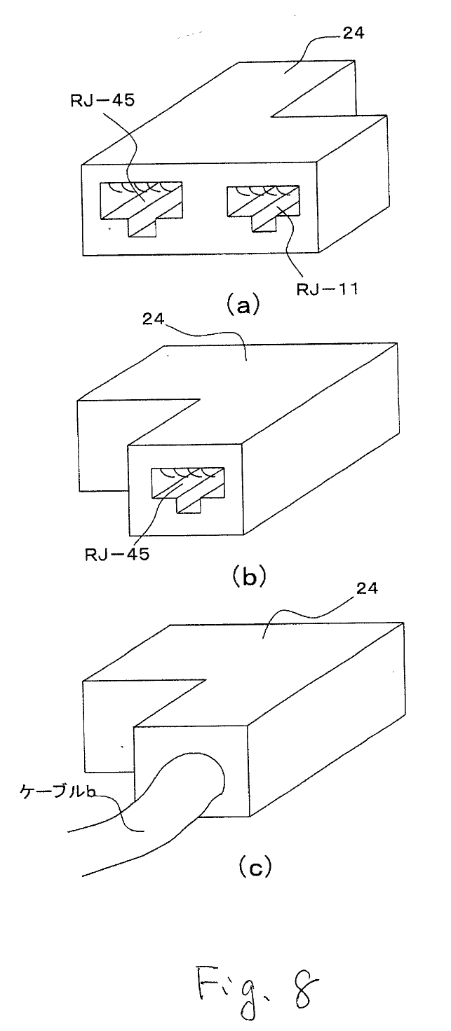

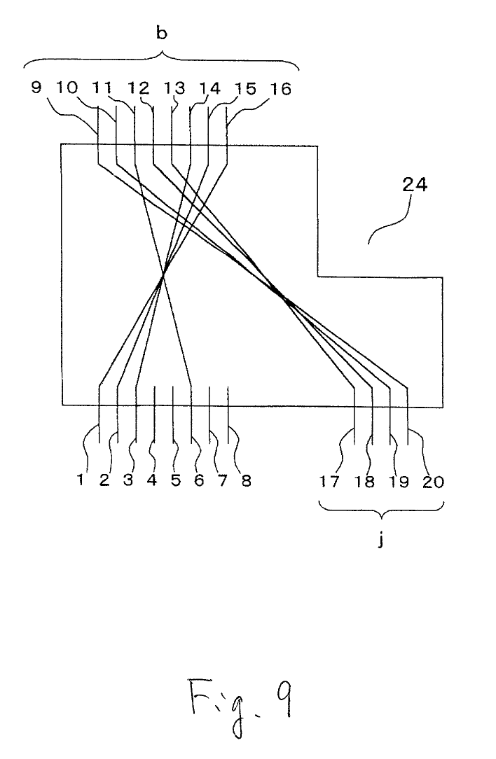

Furthermore, according to the above mentioned embodiment, a combination connector is used, but it can be replaced with a branch adapter. FIGS. 8A, 8B, and 9 show an example of a branch adapter used in this case. FIG. 8A is an oblique view of a branch adapter 24 viewed from the front. FIG. 24B is an oblique view from the reverse side. FIG. 9 shows the wiring inside the branch adapter 24.

In FIG. 9, pins 1 through 18 are jacks for connecting a cable having eight lines, and can be RJ-45 shown in FIG. 8A. Pins 9 through 16 are also jacks for connecting a cable having eight lines, and can be RJ-45 shown in FIG. 8B. On the other hand, pins 17 through 20 are jacks for connecting a telephone cable having four lines, and can be RJ-11. The branch adapter 24 has the following internal connection. That is, the pin 1 is connected to the pin 16, the pin 2 is connected to the pin 15, the pin 3 is connected to the pin 14, the pin 6 is connected to the pin 11, the pin 17 is connected to the pin 13, the pin 18 is connected to the pin 12, the pin 19 is connected to the pin 10, and the pin 20 is connected to the pin 9.

With the above mentioned connection, the above mentioned cable b is connected to the pins 9 through 16 (RJ-45 shown in FIG. 8B), and the cable j is connected to the pins 17 through 20 (RJ-11 shown in FIG. 8A). The above mentioned cable b is connected to the HUB 23, and the cable j is connected to the corresponding push-button telephone T1. Then, the cable connected to the personal computer PC 1 is connected to the pins 1 through 18.

FIG. 8C shows the above mentioned cable b connected to the branch adapter 24. This cable can be replaced with a male connector of the RJ-45 for direct insertion.

With the above mentioned configuration, the above mentioned branch adapter 24 can be mounted between the HUB 23 and the personal computer PC 1 shown in FIG. 5 to have the function of the above mentioned combination connector. That is, the data communications between the HUB 23 and the personal computer PC 1 are established through the pins 1, 2, 3, 6, 16, 15, 14, and 11 in the branch adapter 24, and the mutual voice communications can be established through the pins 9, 10, 12, 13, 20, 19, 18, and 17 in the branch adapter 24.

With the configuration, the voice data can be transmitted and received through the conventional communications network, and a network system can be generated without the problem of discontinuous voice.

<Third Embodiment>

Described next is the third embodiment of the present invention.

The present embodiment relates to a process program with the system configuration according to the second embodiment. As described above, the personal computers PC 1 through PC 4 are connected to the HUB 23 respectively through the corresponding cables b through e. In this case, a connecting protocol is required. For example, in the case of the personal computer PC 1, programs are set in the order of a NIC (a LAN card), a device driver, a controller, and each application. Each application can be a program, etc. for voice communications using a telephone line. For example, it can be a program installed in a personal computer in advance.

To prevent each application from issuing an instruction directly to the device driver, the priority of an application and a connection configuration are controlled in a controller program. In addition, the controller program is added when the above mentioned LAN card is purchased.

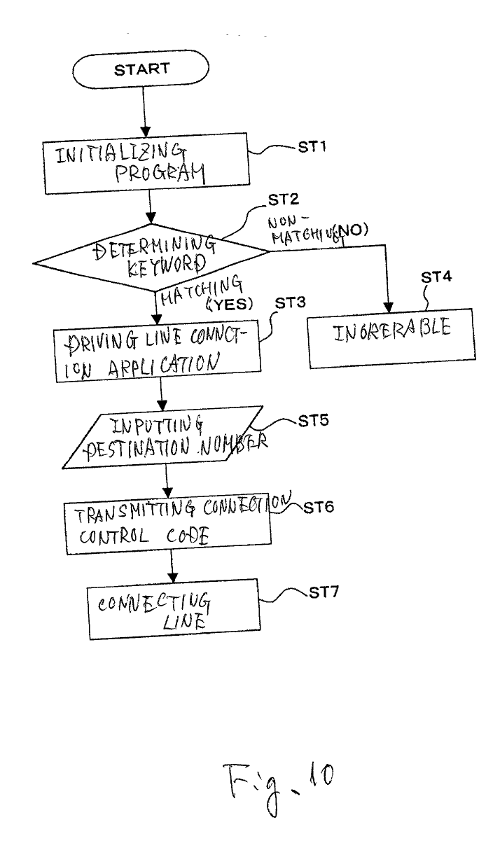

FIG. 10 is a flowchart of the process performed when the system according to the present embodiment is used. First, the program is initialized (step (hereinafter expressed by ST) 1). When it is initialized, a specified keyword is confirmed (ST 2). The keyword is confirmed by exchanging the keywords, for example, between the application and the controller, and between the controller and the device driver. Assume that the specified keyword is ‘zeek’. If the specified keywords match each other (yes in ST 2), then the subsequent application (application for connection of a telephone line) is performed (in and after step ST 3). On the other hand, if the determination (ST 2) outputs a non-matching result (no in ST 2), then the operation is not performed (ST 4). When the initializing process is not performed, the operation of the application is not performed.

When the above mentioned application is performed (ST 3), for example, the mouse (not shown in the attached drawings) is operated to make a phone call, and the telephone number of the destination is input (ST 5). In this input process, for example, the CPU (not shown in the attached drawings) initialized a modem, sets up a protocol, etc. to call up the specified destination (ST 6). In this case, a connection control code is transmitted to the private branch exchange (PBX) 22 through the above mentioned combination connector, the cable b (twisted pair lines 5), the HUB 23, and the telephone lien f (ST 6).

When the connection to the destination has been completed, the communications are started, and voice data is mutually transmitted and received (ST 7). In this case, the twisted pair lines 5 and 6 of the cable b are used with the problem of discontinuous voice, etc. solved.

In the present embodiment, the above mentioned connection control code is transmitted to the private branch exchange (PBX) 22. However, when the HUB 23 having the function of the private branch exchange (PBX) is used, a connection control code is transmitted to the HUB 23.

In the above mentioned process, the current private branch exchange (PBX) is used to transmit voice data to a telephone line, but voice data can also be provided as packet data through a communications network (Ithernet).

<Fourth Embodiment>

Described below is the fourth embodiment of the present invention.

The present embodiment relates to applying a multichannel network to a television telephone according to the present invention.

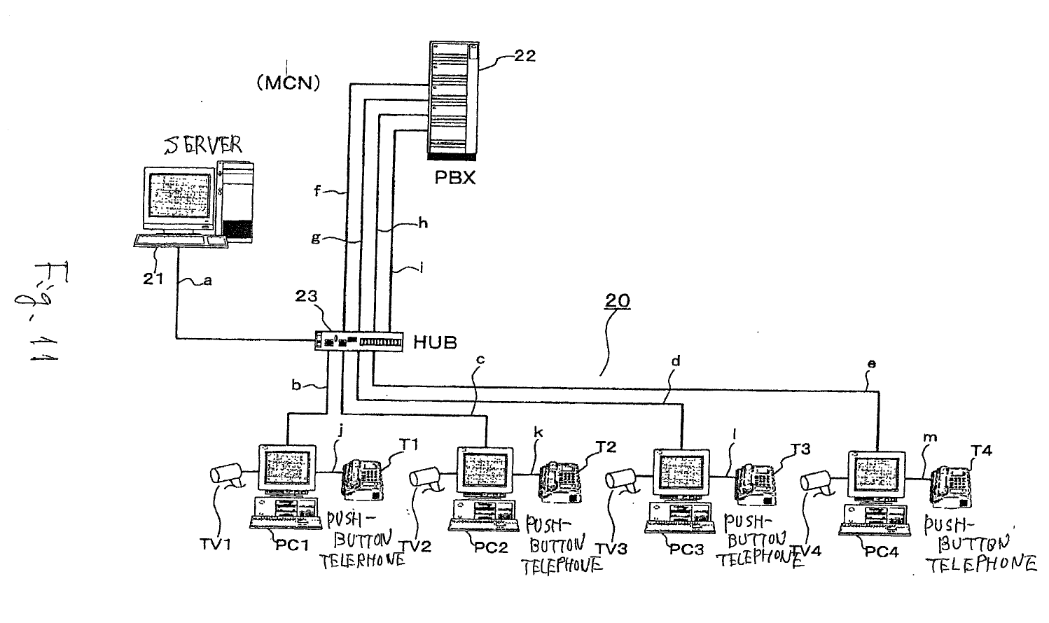

FIG. 11 shows the system according to the present embodiment. In FIG. 11, a television camera is connected to each of the personal computers PC 1 through PC 4 in the system shown in FIG. 5. Otherwise, the system shown in FIG. 11 is the same as the system according to the second embodiment. Therefore, only the points different from those shown in FIG. 5 are described below.

As described above, each of the personal computers PC 1 through PC 4 is connected to the HUB 23 respectively through the cables b through e, and the push-button telephones T1 through T4 are respectively connected to the personal computers PC 1 through PC 4. In addition, a television camera TV 1 is connected to the personal computer PC 1. A television camera TV 2 is connected to the personal computer PC 2. A television camera TV 3 is connected to the personal computer PC 3. A television camera TV 4 is connected to the personal computer PC 4. Furthermore, the television cameras TV 1 through TV 4 can be directly connected to the personal computers PC 1 through PC 4 respectively.

The data captured by the television cameras TV 1 through TV 4 is provided for a dedicated line or communications line through the combination connector in the corresponding personal computers PC 1 through PC 4 respectively. In this case, the twisted pair lines in the cable can be used. For example, by using the twisted pair lines 6, dynamic images can be transmitted to a destination without disturbance.

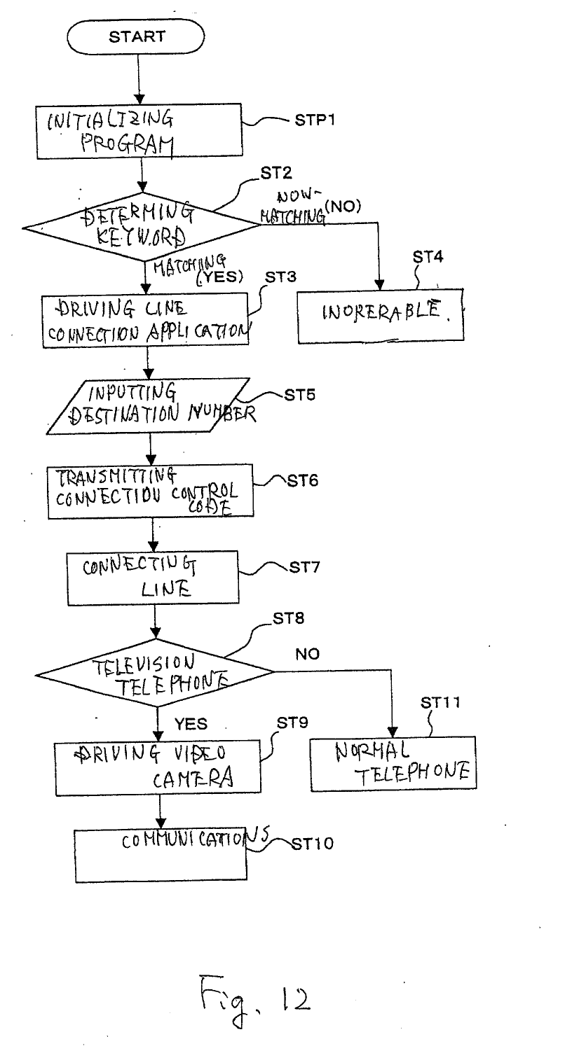

Then, the process performed in this case is described below by referring to the flowchart shown in FIG. 12. The flowchart shown in FIG. 12 partly overlaps the process shown in FIG. 10.

First, the program is initialized (step (hereinafter expressed by STP) 1) as described above, and specified keywords are exchanged for authentication (STP 2). If the specified keywords match each other (yes in STP 2), then the following application is performed (STP 3).

That is, to use a television telephone, a destination is called up (STP 5), and a connection control code is transmitted to the private branch exchange (PBX) 22 (STP 6). When the connection is completed (STP 7), it is determined whether or not it is a television telephone (STP 8). The determination is made according to the key operation signal used when a user operates a television telephone. For example, when a user operates a television telephone, a key operation signal can be issued using the # key or the +key of the corresponding push-button telephones T1 through T4. Additionally, a mouse can be operated to output a corresponding instruction signal. furthermore, a program process can be used to automatically enter a television telephone.

If it is determined that a television telephone is used (yes in step STP 8), then the television camera of a corresponding personal computer (push-button telephone) is driven (STP 9). For example, when the push-button telephone T1 is used, the television camera TV 1 of the corresponding personal computer PC 1 (push-button telephone T1) is driven. When the push-button telephone T2 is used, the television camera TV 2 of the corresponding personal computer PC 2 (push-button telephone T2) is driven.

Therefore, in the above mentioned process, for example, the data captured by the television camera TV 1 is transmitted to the personal computer PC 1, the voice data is transmitted from the push-button telephone T1 to the personal computer PC 1, and these data are transmitted to the dedicated twisted pair lines through the above mentioned combination connector. As a result, ceaseless voice data can be transmitted and received, and pictures can be transmitted and received without disturbance (STP 10).

If it is determined that a television telephone is not used in the above mentioned determination (STP 8), then it is determined that a normal telephone is used (no in STP 8, STP 11). In this case, it can be determined that a normal telephone is used after determining whether or not a video conference is being held. If it is determined whether or not a video conference is being held, a program for connection with another telephone is set up.

<Fifth Embodiment>

Described below is the fifth embodiment of the present invention.

The present embodiment is configured such that the present invention can be realized by a LAN card, especially a PCMCIA standard card.

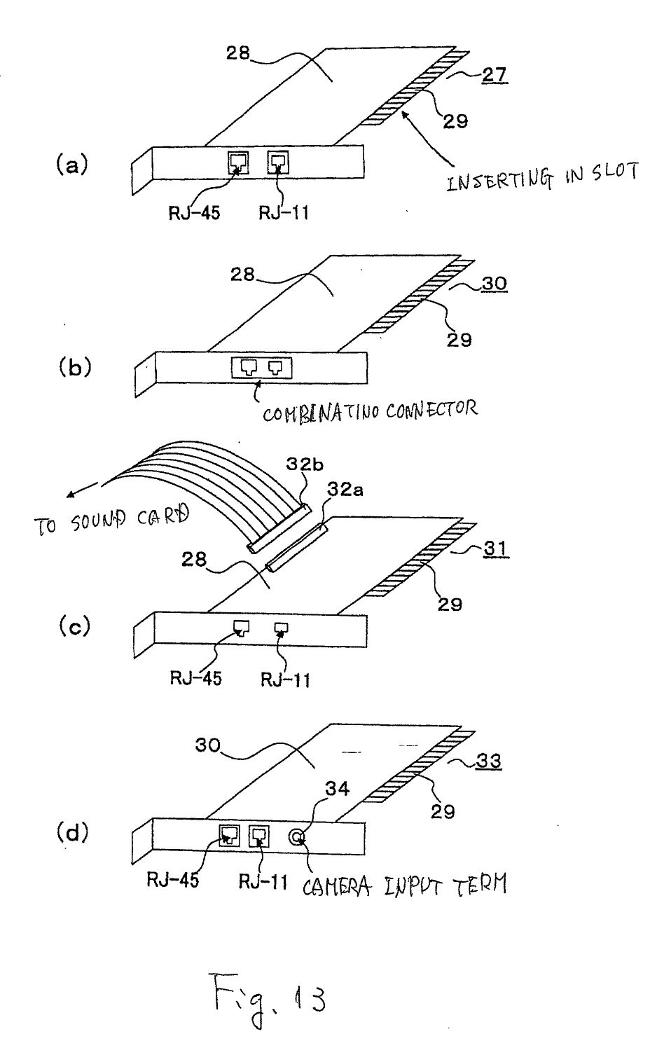

First, FIG. 13A shows an example of a LAN card 27 provided with the connector for the RJ-45 and the connector for the RJ-11. The connector for the RJ-45 and the connector for the RJ-11 are mounted to a board 28 of a LAN card 27, and a plurality of signal terminals 29 to be inserted in the slot of a personal computer are provided on the board 28. Furthermore, a wiring pattern is formed on the board 28 for connection to the connector for the RJ-45 and the connector for the RJ-11, and a communications signal and a voice signal for a telephone are transmitted and received through the LAN card 27.

FIG. 13B shows an example of a LAN card 30 provided with the above mentioned combination connector. In this case, the wiring of the combination connector is connected to the board 28, and the connecting and switching processes are performed by the control of, for example, the personal computers PC 1 through PC 4.

Then, FIG. 13C shows an example of a LAN card 31 capable of connecting a sound card. In this case, a connector 32a is provided for the board 28, and the connector 32a is connected to a smooth line to which a connector 32b is mounted, thereby connecting a sound card to the RJ-45 or the RJ-11 through the LAN card 31. In addition, a terminal can be connected and switched by the control of, for example, the personal computers PC 1 through PC 4.

Finally, FIG. 13D shows an example of a LAN card 33 having a camera input terminal. It is an example of a LAN card used in, for example, the above mentioned fourth embodiment, and a pick-up signal of a television camera is input from a camera input terminal 34. With the configuration, a pick-up signal (animation data) input from the camera input terminal 34 is fetched into the personal computers PC 1 through PC 4 through the board 28, and provided for the RJ-45, and the pick-up signal (animation data) is switched and connected.

<Other Embodiments>

The first through fifth embodiments have been described above, but the present invention is not limited to the above mentioned embodiments. For example, when the body of a personal computer is turned off (when power is not applied to a LAN card), the LAN card can be directly connected.

Furthermore, depending on the data type such as voice, animation, etc., the present invention is not limited to the above mentioned embodiment only if data can be transmitted and received by connecting data between a source and a destination through a substantially exclusive connection although there arises a relaying, branching, or replicating process.

A network including a server and a client has been described in the above mentioned embodiments, but the present invention is not limited to the network with the configuration. Furthermore, the number of personal computers connected to the network 20 is not limited to four, but can be an arbitrary number.

Furthermore, in FIG. 5 referred to in the second embodiment, and in FIG. 11 referred to in the fourth embodiment, the push-button telephones T1 through T4 are used as telephones. However, the telephones are not limited to the push-button telephones T1 through T4, but can be normal home telephones. In this case, two twisted pair lines are used. For example, mutual voice communications can be established using 2 twisted pair lines 5 described by referring to FIG. 2.

As described above in detail, according to the present invention, data assigned to each channel is transmitted and received without interference by other channels with the problems of discontinuous voice or animation successfully solved.

Furthermore, a terminal devices such as a telephone, etc. mounted near a personal computer can be wired using the same cable, thereby simplifying the cable management, and reducing the cable mounting cost.

In addition, a television telephone can be easily installed. Therefore, a telephone can be used in a video conference, etc. with a mike or a speaker for a video conference can be omitted.

Furthermore, using a LAN card to which a signal can be input and a sound card can be connected, a multichannel network according to the present invention can be more easily realized.

Additionally, using a home telephone as described above, a system can be designed with a less expensive telephone.

What is claimed is:

1. A multichannel network for transmitting data of different types through respective channels in a plurality of physical transmission media.

2. A network connection device according to claim 1, wherein
some of a plurality of channels are externally branched and output.

3. A network connection and switch device having functions of individually switching and connecting a lurality of channels.

4. The device according to claim 3, wherein
said network connection and switch device is a HUB.

5. A multichannel network having a plurality of terminal device comprising a computer and appliances connected to the computer, wherein:
said computer and a server are connected to a cable storing lines for different channels respectively for different types of data; and
said computer and said appliances connected to said computer transmit and receive data to and from a destination through the line for different channels.

6. The network according to claim 5, wherein
said appliance connected to said computer is a telephone.

7. The network according to claim 5, wherein
said appliance connected to said computer is a television camera.

8. The network according to claim 5, further comprising
a branch device transmitting data to said computer and said appliances connected to said computer, wherein
said branch device transfers data to said computer and said appliances connected to said computer for each channel.

9. The network according to claim 8, wherein
said branch device is provided in said computer.

10. The network according to claim 5, wherein
said computer comprises programs respectively for a device driver, a controller, and an application, and said device driver and said controller, and said controller and said application mutually exchange specified keywords, and start a control process when an initializing process is performed.

11. The network according to claim 5, further comprising
a LAN card set to directly connect a line of the telephone when said computer is turned off.

12. A LAN card having a function of inputting telephone voice.

13. A LAN card having a function of inputting a camera.

14. A LAN card having a function of including a voice line in a sound card.
